(19) United States
(12) Patent Application Publication
(10) Pub. No.: US 2015/0178292 A1
(43) Pub. Date: Jun. 25, 2015

(54) METHODS AND SYSTEMS FOR DATA SERIALIZATION AND DESERIALIZATION

(71) Applicant: TENCENT TECHNOLOGY (SHENZHEN) COMPANY LIMITED, Shenzhen (CN)

(72) Inventor: ZHIMING NIE, Shenzhen (CN)

(73) Assignee: TENCENT TECHNOLOGY (SHENZHEN) COMPANY LIMITED, Shenzhen (CN)

(21) Appl. No.: 14/261,655

(22) Filed: Apr. 25, 2014

Related U.S. Application Data
(63) Continuation of application No. PCT/CN2013/089937, filed on Dec. 19, 2013.

(51) Int. Cl. G06F 17/30

(52) U.S. Cl. CPC G06F 17/30076; G06F 17/3012

(57) ABSTRACT

A method and system for data serialization and deserialization are disclosed. The method includes obtaining a first metafile; obtaining structured data to be serialized; and serializing the structured data based on the first metafile, the serialized data following a format of (length, value) or a format of (value) for each data field. The method further includes obtaining a second metafile; obtaining the serialized data; and deserializing the serialized data based on the second metafile. The disclosed method and system enable a more efficient data serialization and deserialization process.

### CROSS-REFERENCES TO RELATED APPLICATIONS

### Related Applications

This application is a continuation application of PCT Patent Application No. PCT/CN2013/089937, filed on Dec. 19, 2013, which is based upon and claims the benefit of priority from Chinese Patent Application No. 201310163947.X, filed on May 7, 2013, the entire contents of all of which are incorporated herein by reference.

### FIELD OF THE INVENTION

The present disclosure relates to network data exchange technologies and, more particularly, to methods and systems for data serialization and deserialization.

### BACKGROUND

In the field of Internet and network data related technologies, more and more data are exchanged over the networks. For example, online computer games often require large amount of data being exchanged over networks and across devices. To efficiently exchange data, computer systems often implement data serialization and deserialization technologies.

One example of the data serialization and deserialization technologies is the Protocol Buffer language developed by Google. Protocol Buffers are methods for data serialization. The method involves a data description language that describes the structure of certain data and a program that generates from that description source code in various programming languages for generating or parsing a stream of bytes that represents the stars structured data.

Data serialization refers to the process of translating data structures or object state into a format that can be stored and resurrected later in the same or another computer environment. The opposite operation, extracting a data structure from a series of bytes, is data deserialization. For example, “Person” may be a type of object; and a “person” may be one object. The process to translate the data of “person” into an extensible mark-up language (e.g., XML) is data serialization. The process to extract the “person” object from the extensible mark-up language data is data deserialization. In this example “Person” is the structure of the data “person.” The format that can be stored and resurrected later in the same or another computer environment is XML. XML provides a method for data serialization. The advantages of XML are that it is simple, widely used, text-based, and can be easily understood by humans. XML, however, is inefficient and not compact.

Often, the more efficient data serialization programs use binary format. That is, the data serialization software programs convert structured data into binary′ format data streams. The programs may then extract the structured data from a binary data stream. For example, Protocol Buffer serializes data into a binary TLV (Tag, Length, Value) format, in which Tag refers to the kind of data this part of the data represents. Tag may also be a data type ID or a data field ID. Based on the Tag ID, the Protocol Buffer may synchronize the serialized data with its data structure and deserialize the data. Tag data is descriptive of the data being transmitted, not a part of the data. As such, adding Tags to serialized data stream increases the size of the data stream. Using Tag data to deserialize data also may be inefficient in certain cases.

The disclosed method and system are directed to solve one or more problems set forth above and other problems.

### BRIEF SUMMARY OF THE DISCLOSURE

Embodiments consistent with the present disclosure provide a method, system, user terminal, or a server for serializing and deserializing data. Embodiments consistent with the present disclosure provide improved data transmission speed and efficiency.

One aspect of the present disclosure provides a method for data serialization and deserialization. The method includes obtaining a first metafile; obtaining structured data to be serialized; and serializing the structured data based on the first metafile, the serialized data following a format of (length, value) or a format of (value) for each data field. The method further includes obtaining a second metafile; obtaining the serialized data; and deserializing the serialized data based on the second metafile.

Another aspect of the present disclosure provides a system for data serialization and deserialization. The system includes a first obtaining unit configured to obtain a first metafile; a second obtaining unit configured to obtain a structured data to be serialized; and a serializing unit configured to serialize the structured data based on the first metafile, the serialized data following a format of (length, value) or a format of (value) for each data field. The system further includes a third obtaining unit configured to obtain a second metafile; a fourth obtaining unit configured to obtain the serialized data; and a deserializing unit configured to deserialize the serialized data based on the second metafile.

Embodiments consistent with the present disclosure provide a method and a system for data serialization. The system may obtain a first metafile. The system may obtain structured data and serialize the structured data based on the first metafile. Embodiments consistent with the present disclosure serialize and deserialize data using fewer data descriptions in addition to the body of the data. Embodiments consistent with the present disclosure thus reduce the resources consumed by data transmission and increase the efficiency of data transmission. Further, embodiments consistent with the present disclosure also increase the efficiency of the data deserialization process.

Embodiments consistent with the present disclosure provide a method for deserializing data. The system may obtain a second metafile and deserialize the data based on the descriptions provided in the second metafile. Embodiments consistent with the present disclosure simplify the deserialization process.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flowchart of a method for data serialization implemented by an exemplary embodiment consistent with the present disclosure;

FIG. 2 is another flowchart of a method for data serialization implemented by an exemplary embodiment consistent with the present disclosure;

FIG. 3 is a flowchart of a method for data deserialization implemented by an exemplary embodiment consistent with the present disclosure;

FIG. 4 is another flowchart of a method for data deserialization implemented by an exemplary embodiment consistent with the present disclosure;

FIG. 5 is a schematic diagram of an exemplary system for data serialization consistent with the present disclosure;

FIG. 6 is a schematic diagram of an exemplary system for data deserialization consistent with the present disclosure;

FIG. 7 illustrates an exemplary operating environment incorporating certain disclosed embodiments; and

FIG. 8 illustrates a block diagram of an exemplary computer system consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

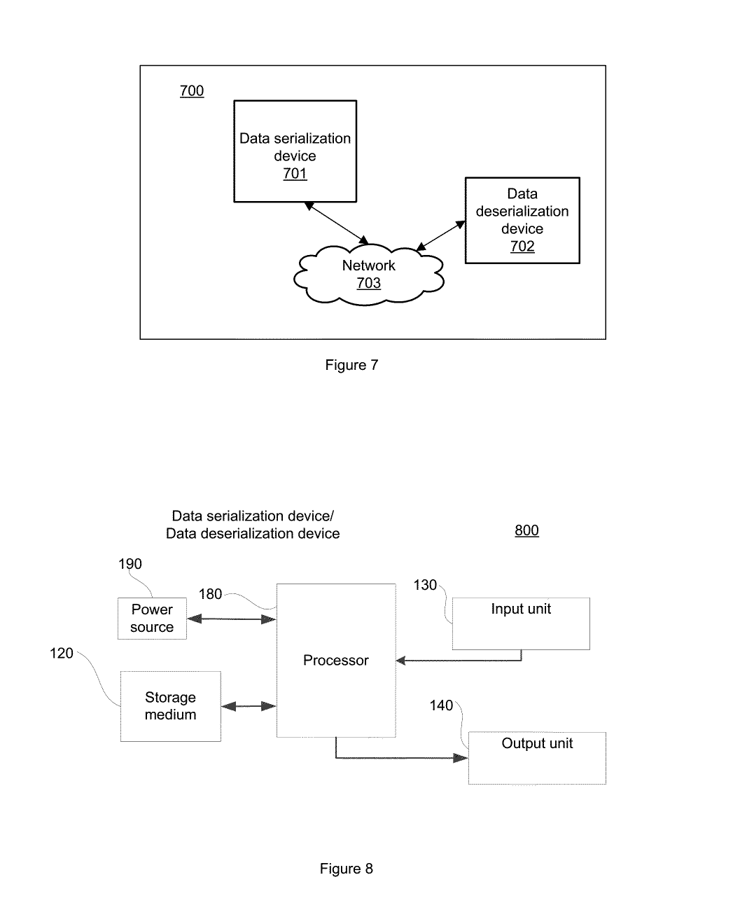

FIG. 7 illustrates an exemplary computer environment 700 incorporating certain disclosed embodiments. As shown in FIG. 7, environment 700 may include a data serialization device 701, a data deserialization device 702, and a network 703. The network 703 may include any appropriate type of communication network for providing network connections to the data serialization device 701 and the data deserialization device 702. For example, network 703 may include the Internet, LAN (Local Area Network), or other types of computer networks or telecommunication networks, either wired or wireless.

The data serialization device 701 and the data deserialization device 702 may include any appropriate type of network computing devices, such as PCs, tablet computers, smartphones, network TVs, etc. The data serialization device 701 and the data deserialization device 702 may include one or more applications. The applications may include any appropriate software application, hardware application, or a combination thereof to achieve certain data serialization functionalities, such as serializing or deserializing data. For example, the application may be the Protocol Buffer program, which may serialize and deserialize data. Any number of applications may be included in the environment 700.

The data serialization device 701 may obtain a first metafile. The data serialization device 701 may obtain structured data and serialize the structured data based on the first metafile. The data deserialization device 702 may obtain a second metafile. The data deserialization device 702 may obtain serialized data and deserialize the data based on the second metafile.

The first metafile and the second metafile may be the same or may have compatible data descriptions. Further, the data serialization and deserialization processes depend on the sequence of data field descriptions. When the protocol is being changed or upgraded, the upgraded protocol may add new data fields, new version numbers, etc., to the end of the metafile. That is, the existing data descriptions in the metafile should not be changed.

Embodiments consistent with the present disclosure provide a method and a system for data serialization. The system may obtain a first metafile. The system may obtain structured data and serialize the structured data based on the first metafile. Embodiments consistent with the present disclosure serialize and deserialize data using fewer data descriptions in addition to the body of the data. Embodiments consistent with the present disclosure thus reduce the resources consumed by data transmission and increase the efficiency of data transmission. Further, embodiments consistent with the present disclosure also increase the efficiency of the data deserialization process.

Embodiments consistent with the present disclosure provide a method for deserializing data. The system may obtain a second metafile and deserialize the data based on the descriptions provided in the second metafile. Embodiments consistent with the present disclosure simplify the deserialization process.

The data serialization device 701 and the data deserialization device 702 may be implemented on any appropriate computing platform. FIG. 8 illustrates a block diagram of an exemplary computer system 800 capable of implementing the data serialization device 701 and the data deserialization device 702.

As shown in FIG. 8, computer system 800 may include a processor 180, storage medium 120, an input unit 130, an output unit 140, and a power source 190. Certain components may be omitted and other components may be included.

The processor 180 may include any appropriate processor or processors. Further, the processor 180 can include multiple cores for multi-thread or parallel processing. The storage medium 120 may include memory modules, such as Read-only Memory (ROM), Random Access Memory (RAM), flash memory modules, and erasable and rewritable memory, and mass storages, such as CD-ROM, U-disk, and hard disk, etc. The storage medium 120 may store computer programs for implementing various processes, when executed by the processor 180.

Further, the input unit 130 may include I/O devices such as a keyboard and a mouse. The computer system 800 may include network devices for establishing connections through the communication network 703

The processor 180 is the control center of the data serialization system. The processor 180 uses interfaces and connections throughout the components of the computer to operate the software programs stored in the storage medium 120, to process the data stored in the storage medium 120, and to implement the functions of the data serialization system. The processor 180 may include one or more core processors. The processor 180 may integrate an application processor and a wireless communication processor. The application processor may control the operation system, user interface, and application programs. The wireless communication processor may control the wireless communications. The wireless communication processor may also be outside the processor 180.

The data serialization system may include the power source 190 (e.g., battery). The power source 190 may use a power management system to connect with the processor 180. The power management system may manage the charging, discharging, and other power management functions. The power source 190 may include one or more DC or AC power sources, charging systems, a power failure detection circuit, a power converter or inverter, and a power status indicator.

In operation, the processor 180 may obtain a first metafile. The metafile file may be an XML file, which is human readable and describes the structure of the structured data. The first metafile may include the sequence and type of data, version number (supporting backward compatibility), etc. The metafiles used in the present disclosure are exemplary, and do not limit the present disclosure.

The first metafile may be entered by a user. The system for data serialization may also obtain the metafile based on the structure of the data (to be serialized) in its database. The system may record the type of data, sequence, etc. into the first metadata.

The processor 180 may obtain structured data. The structured data may be stored in a database. The structured data may be described by a two-dimension table. Based on the first metafile, the processor 180 may serialize the obtained structured data. Here, the processor 180 utilizes the data structure described in the first metafile to serialize the structured data. For example, a first metafile may describe that the structured data include a floating point number and a string. The metafile further indicate that the floating point number should be serialized first, followed by the string. The metafile may also include other information related to the structured data. In some embodiments consistent with the present disclosure, the byte stream (serialized date) generated may include a length and a value or only a value of the data.

Embodiments consistent with the present disclosure provide a method and a system for data serialization. The system may obtain a first metafile. The system may obtain structured data and serialize the structured data based on the first metafile. Embodiments consistent with the present disclosure serialize and deserialize data using fewer data descriptions in addition to the body of the data. Embodiments consistent with the present disclosure thus reduce the resources consumed by data transmission and increase the efficiency of data transmission. Further, embodiments consistent with the present disclosure also increase the efficiency of the data deserialization process.

Further, in operation, for data deserialization, the 180 processor may obtain a second metafile. The second metafile may describe data sequence or data types. The second metafile may be entered by a user. The processor may also generate the second metafile based on the relevant data structure.

The processor 180 may obtain serialized data. The serialized data may be binary, but are not limited to binary data. Based on the second metafile, the processor 180 may deserialize the serialized data. In this step, the processor 180 may cycle through all segments of the serialized data until it reaches the end. If the system fails to deserialize the serialized data, it may generate an error message.

The second metafile contains the description for the serialized data. The system may then deserialize the serialized data based on the second metafile. For example, a second metafile may indicate that the serialized data contain floating point numbers and strings. Based on the second metafile, the system may deserialize the serialized data as described below.

First, the system may analyze the bytes correspond to a floating point number. Because floating point numbers have a fixed length of 4 bytes, the system may move the 4 bytes of data and assign the value to the floating point number data field. The system may them move to the fifth byte of the data.

Second, the system may analyze the bytes corresponding to a string. A string may have a variable length. The system may check the string length in the fifth byte of the serialized data (e.g., L=3). The system may then move the 3 bytes of data and assign it to the string data field.

As the exemplary protocol has only two data fields (floating point number and string), the processor has finished deserializing the data. As shown in this example, the deserialization is based on the data descriptions provided in the protocol. The first metafile and the second metafile may be the same or may have compatible data descriptions. Further, the data serialization and deserialization processes depend on the sequence of the data field descriptions. When the protocol is being changed or upgraded, the upgraded protocol may add new data fields, new version numbers, etc., to the end of the metafile. That is, the existing data descriptions in the metafile should not be changed.

Embodiments consistent with the present disclosure provide a method for deserializing data. The system may obtain a second metafile and deserialize the data based on the descriptions provided in the second metafile. Embodiments consistent with the present disclosure simplify the deserialization process.

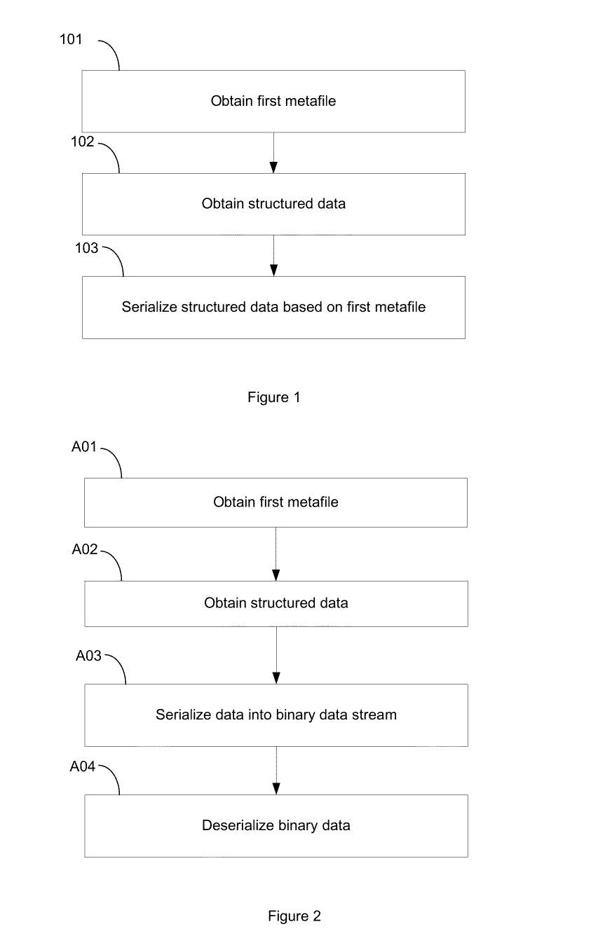

FIG. 1 is a flow chart of a method for data serialization implemented by embodiments consistent with the present disclosure. The method describe in relation to FIG. 1 includes steps 101-103. In step 101, a system for data serialization may obtain a first metafile. The metafile file may be an XML file, which is human readable and describes the structure of structured data. The first metafile may include the sequence and type of the data fields, version number (supporting backward compatibility), etc. The metafiles used in the present disclosure are exemplary, and do not limit the present disclosure.

The first metafile may be entered by a user. The system for data serialization may also obtain the metafile based on the structure of the data (to be serialized) in its database. The system may record the type of data, sequence, etc. into the first metadata.

For example, system A and system B may exchange communication protocols. Both system A and system B may have the metafile as follows:

```
<struct name=”person” version=”1”>
  <entry name=”age” type=”int” />
  <entry name=”name” type=”string” size=”32” />
</struct>
```

For the convenience of description, assuming system A sends data communication protocols to system B. Base on the metafile, system A may serialize the structured data and generate an output byte stream (without the Tag information). System A may then send the output byte stream to system B. System B may then use the metafile to deserialize the byte stream into structured data. Systems A and B in this example refer to software and/or hardware used to serialize and deserialize data.

Specifically, the data serialization process implemented by system A may be as follows (DR refers to the software program for data serialization and deserialization):

meta_semantics = DR.load(metafile);
DR.serialize(INPUT meta_semantics,
INPUT local_object, OUTPUT byte_stream);
Net.send(byte_stream);

The data deserialization process implemented by system B may be as follows:

meta_semanties = DR.load(metafile);
Net.recv(byte_stream)
DR.deserialize(INPUT meta_semanties,
INPUT byte_stream, OUTPUT local_object);

In the above processes, DR refers to the software program for data serialization and deserialization. INPUT refers to the input data. OUTPUT refers to the output data. “local_object” refers to a data object with its structure described by the metafile. Before data serialization and deserialization, systems A and/or B may load the metafile and generate meta_semantics which can be used by the data serialization and deserialization software. In this example, the data serialization and deserialization performed by systems A and B are based on the data structure described by the meta_semantics. Systems A and B are compatible and communicate with each other.

Referring back to step 101, the system for data serialization may obtain a first metafile. The metafile may be entered by a user. The system may also generate the metafile based on the relevant data structure.

In step 102, the system may obtain structured data. The structured data may be stored in a database. The structured data may be described by a two-dimension table. In step 103, based on the first metafile, the system may serialize the obtained structured data. Here, the system may utilize the data structure described in the first metafile to serialize the structured data. For example, a first metafile may describe that the structured data include a floating point number and a string. The metafile may further indicate that the floating point number should be serialized first, followed by the string. The metafile may also include other information related to the structured data. In some embodiments consistent with the present disclosure, the byte stream (serialized date) generated in step 103 may include a length and a value or only a value.

Embodiments consistent with the present disclosure provide a method and a system for data serialization. The system may obtain a first metafile. The system may obtain structured data and serialize the structured data based on the first metafile. Embodiments consistent with the present disclosure serialize and deserialize data using fewer data descriptions in addition to the body of the data. Embodiments consistent with the present disclosure thus reduce the resources consumed by data transmission and increase the efficiency of data transmission. Further, embodiments consistent with the present disclosure also increase the efficiency of the data deserialization process.

FIG. 2 shows another flow chart of a method for data serialization implemented by embodiments consistent with the present disclosure. The method includes steps A01-A04. In step A01, the system for data serialization may obtain a first metafile. In step A02, the system may obtain the structured data to be serialized. In step A03, the system may cycle through the structured data based on the first metafile to generate serialized binary data. In step A04, the system may implement the data deserialization process. If the system fails to serialize the structured data at step A03, it stops at step A03 and does not move to step A04. The serialized binary data may include a value portion (Value) and an optional length portion (Length). The data serialization implemented in step A03 refers to the process of serializing structured data.

Embodiments consistent with the present disclosure provide a method and a system for data serialization. The system may obtain a first metafile. The system may obtain structured data and serialize the structured data based on the first metafile. Embodiments consistent with the present disclosure serialize and deserialize data using fewer data descriptions in addition to the body of the data. Embodiments consistent with the present disclosure thus reduce the resources consumed by data transmission and increase the efficiency of data transmission. Further, embodiments consistent with the present disclosure also increase the efficiency of the data deserialization process.

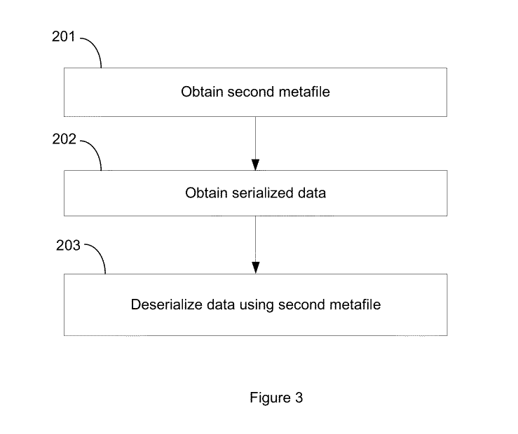

FIG. 3 shows a flow chart of a method for data deserialization implemented by embodiments consistent with the present disclosure. The method includes steps 201-203. In step 201, the system for data deserialization may obtain a second metafile. The second metafile may describe data sequence or data types. The second metafile may be entered by a user. The system may also generate the second metafile based on the relevant data structure.

In step 202, the system may obtain serialized data. The serialized data may be binary, but are not limited to binary data. In step 203, based on the second metafile, the system may deserialize the serialized data. In this step, the system may cycle through all segments of the serialized data until it reaches the end. If the system fails to deserialize the serialized data, it may generate an error message.

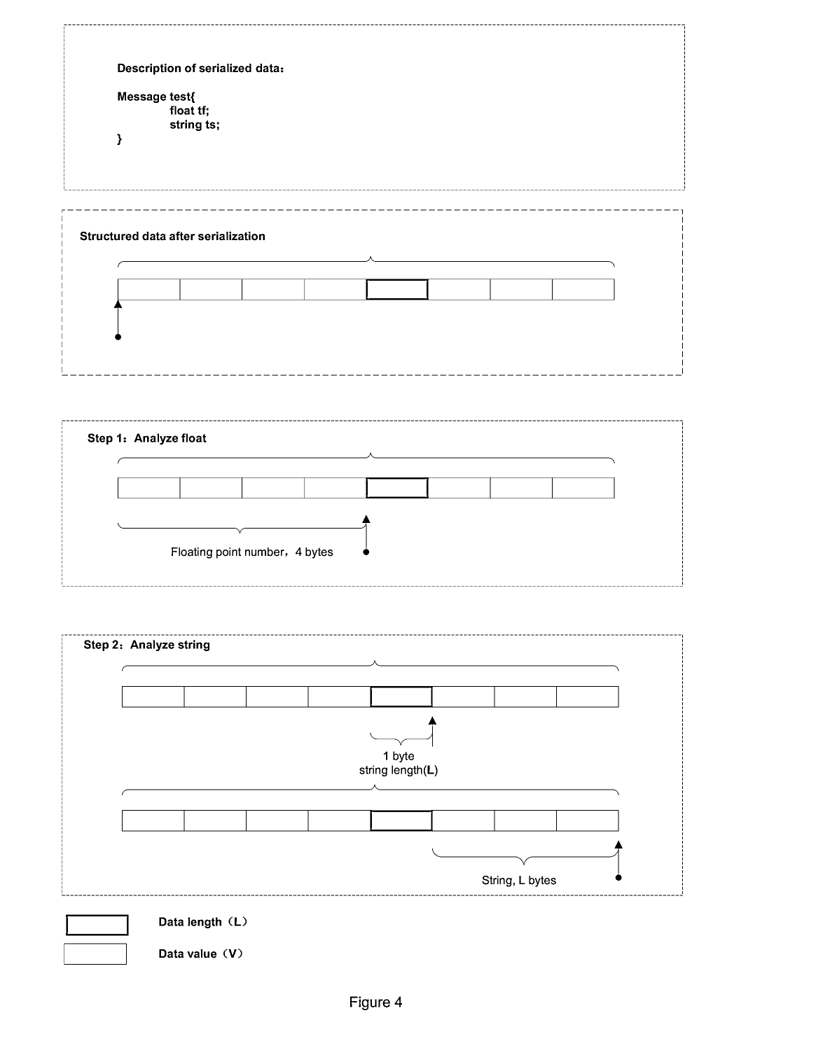

In FIG. 3, the second metafile contains the description for the serialized data. The system may then deserialize the serialized data based on the second metafile. For example, as shown in FIG. 4, a second metafile may indicate that the serialized data contain floating point numbers and strings. Based on the second metafile, the system may deserialize the serialized data as described below.

First, the system may analyze the bytes correspond to a floating point number. Because floating point numbers have a fixed length of 4 bytes, the system may move the 4 bytes and assign the value to the floating point number tf. The system may them move to the fifth byte of the data.

Second, the system may analyze the bytes correspond to a string. A string may have a variable length. The system may check the string length in the fifth byte of the serialized data (in FIG. 4, L=3). The system may then move the 3 bytes of data and assign it to string ts.

As the test protocol has only two data fields (as shown in the second metafile), the system has finished deserializing the data. As shown in this example, the deserialization is based on the data descriptions provided in the protocol. As shown in FIGS. 1-4, the first metafile and the second metafile may be the same or may have compatible data descriptions. Further, the data serialization and deserialization processes depend on the sequence of data field descriptions. When the protocol is being changed or upgraded, the upgraded protocol may add new data fields, new version numbers, etc., to the end of the metafile. That is, the existing data descriptions in the metafile should not be changed.

Embodiments consistent with the present disclosure provide a method for deserializing data. The system may obtain a second metafile and deserialize the data based on the descriptions provided in the second metafile. Embodiments consistent with the present disclosure simplify the deserialization process.

FIG. 5 shows a schematic diagram of an exemplary system for data serialization consistent with the present disclosure. The system includes a first obtaining unit 501, a second obtaining unit 502, and a serialization unit 503.

The first obtaining unit 501 may obtain a first metafile. The metafile file may be an XML file, which is human readable and describes the structure of the structured data. The first metafile may include the sequence and type of data fields, version number (supporting backward compatibility), etc. The metafiles used in the present disclosure are exemplary, and do not limit the present disclosure.

The first metafile may be entered by a user. The first obtaining unit 501 may also obtain the metafile based on the structure of the data (to be serialized) in its database. The system may record the type of data, sequence, etc. into the first metadata.

The second obtaining unit 502 may obtain structured data. The structured data may be stored in a database. The structured data may be described by a two-dimension table. Based on the first metafile, the serialization unit 503 may serialize the obtained structured data. The serialization unit 503 may use the data structure described in the first metafile to serialize the structured data. For example, a first metafile may describe that the structured data include a floating point number and a string. The metafile further indicate that the floating point number should be serialized first, followed by the string. The metafile may also include other information related to the structured data. In some embodiments consistent with the present disclosure, the byte stream (serialized date) generated by the serialization unit 503 may include a length and a value or only a value.

Embodiments consistent with the present disclosure provide a method and a system for data serialization. The system may obtain a first metafile. The system may obtain structured data and serialize the structured data based on the first metafile. Embodiments consistent with the present disclosure serialize and deserialize data using fewer data descriptions in addition to the body of the data. Embodiments consistent with the present disclosure thus reduce the resources consumed by data transmission and increase the efficiency of data transmission. Further, embodiments consistent with the present disclosure also increase the efficiency of the data deserialization process.

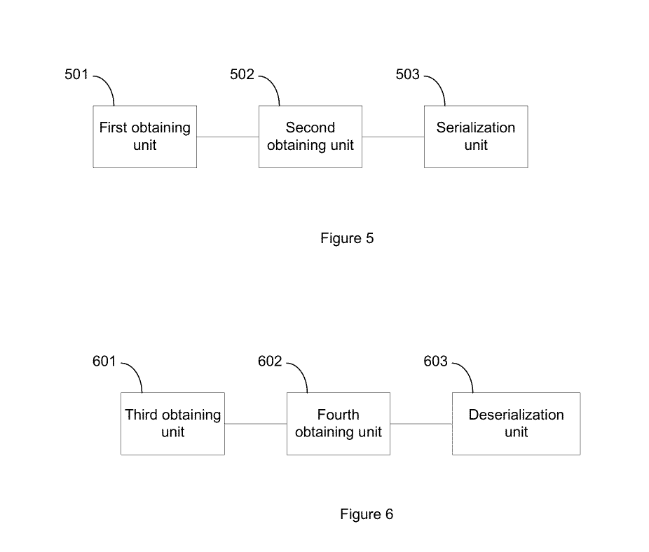

FIG. 6 shows a schematic diagram of an exemplary system for data deserialization consistent with the present disclosure. The system includes a third obtaining unit 601, a fourth obtaining unit 602, and a deserialization unit 603.

The third obtaining unit 601 may obtain a second metafile. The second metafile may describe data sequence or data types. The second metafile may be entered by a user. The third obtaining unit 601 may also generate the second metafile based on the relevant data structure.

The fourth obtaining unit 602 may obtain serialized data. The serialized data may be binary, but are not limited to binary data. Based on the second metafile, the deserialization unit 603 may deserialize the serialized data. In this step, the deserialization unit 603 may cycle through all segments of the serialized data until it reaches the end. If the deserialization unit 603 fails to deserialize the serialized data, it may generate an error message.

In the present disclosure, the second metafile contains the description for the serialized data. The system may then deserialize the serialized data based on the second metafile. For example, as shown in FIG. 4, a second metafile may indicate that the serialized data contain floating point numbers and strings. Based on the second metafile, the system may deserialize the serialized data as described below.

First, the system may analyze the bytes correspond to a floating point number. Because floating point numbers have a fixed length of 4 bytes, the system may move the 4 bytes and assign the value to the floating point number tf. The system may them move to the fifth byte of the data.

Second, the system may analyze the bytes correspond to a string. A string may have a variable length. The system may check the string length in the fifth byte of the serialized data (in FIG. 4, L=3). The system may then move the 3 bytes of data and assign it to string ts.

As the test protocol has only two data fields (shown in the second metafile), the system has finished deserializing the data. As shown in this example, the deserialization is based on the data descriptions provided in the protocol. As shown in FIGS. 1-4, the first metafile and the second metafile may be the same or may have compatible data descriptions. Further, the data serialization and deserialization processes depend on the sequence of data field descriptions. When the protocol is being changed or upgraded, the upgraded protocol may add new data fields, new version numbers, etc., to the end of the metafile. That is, the existing data descriptions in the metafile should not be changed.

Embodiments consistent with the present disclosure provide a method for deserializing data. The system may obtain a second metafile and deserialize the data based on the descriptions provided in the second metafile. Embodiments consistent with the present disclosure simplify the deserialization process.

Consistent with embodiments of the present disclosure, one or more non-transitory storage medium storing a computer program are provided to implement the system and method for data serialization and deserialization. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various systems for data serialization and deserialization may be implemented. For example, an online computer game terminal may exchange a large amount of data with a server. To facilitate faster data transfers, the terminal and server may serialize and deserialize data based on descriptions provided in metafiles. By transferring data using embodiments of the present disclosure, a system may achieve faster data transmission rate and use the network resources more efficiently.

What is claimed is:

1. A method for data serialization, comprising:
obtaining a first metafile;
obtaining structured data to be serialized; and
serializing the structured data based on the first metafile, the serialized data following a format of (length, value) or a format of (value) for each data field.

2. The method according to claim 1, further comprising:
receiving the first metafile from a user.

3. The method according to claim 2, further comprising:
generating the first metafile based on a structure of the structured data.

4. The method according to claim 1, wherein the (length, value) format specifies a length of a data type, and a value for the data type; and the (value) format specifies a value for a fixed length data type.

5. The method according to claim 1, further comprising:
serializing a segment of the structured data based on the first metafile;
serializing next segment of the structured data if the previous segment is successfully serialized; and
generating an error message if the previous segment is not successfully serialized.

6. A method for data deserialization, comprising:
obtaining a first metafile;
obtaining serialized data to be extracted, the serialized data following a format of (length, value) or a format of (value) for each data field; and
deserializing the serialized data based on the first metafile.

7. The method according to claim 6, further comprising:
receiving the first metafile from a user.

8. The method according to claim 6, wherein the (length, value) format specifies a length of a data type, and a value for the data type; and the (value) format specifies a value for a fixed length data type.

9. The method according to claim 6, further comprising:
deserializing a segment of the serialized data based on the first metafile;
deserializing next segment of the serialized data if the previous segment is successfully deserialized; and
generating an error message if the previous segment is not successfully deserialized.

10. A system for data serialization, comprising:
a first obtaining unit configured to obtain a first metafile;
a second obtaining unit configured to obtain structured data to be serialized; and
a serializing unit configured to serialize the structured data based on the first metafile, the serialized data following a format of (length, value) or a format of (value) for each data field.

11. The system according to claim 10, wherein the first obtaining unit is further configured to receive the first metafile from a user.

12. The system according to claim 11, wherein the first obtaining unit is further configured to generate the first metafile based on a structure of the structured data.

13. The system according to claim 10, wherein the (length, value) format specifies a length of a data type, and a value for the data type; and the (value) format specifies a value for a fixed length data type.

14. The system according to claim 10, wherein the serialization unit is further configured to serialize a segment of the structured data based on the first metafile; serialize next segment of the structured data if the previous segment is successfully serialized; and generate an error message if the previous segment is not successfully serialized.

15. A system for data deserialization, comprising:
a first obtaining module obtaining a first metafile;
a second obtaining unit configured to obtain serialized data to be extracted, the serialized data following a format of (length, value) or a format of (value) for each data field; and
a deserializing unit configured to deserialize the serialized data based on the first metafile.

16. The system according to claim 15, wherein the first obtaining unit is further configured to receive the first metafile from a user.

17. The system according to claim 15, wherein the (length, value) format specifies a length of a data type, and a value for the data type; and the (value) format specifies a value for a fixed length data type.

18. The system according to claim 15, wherein the deserializing unit is further configured to deserialize a segment of the serialized data based on the first metafile; deserialize next segment of the serialized data if the previous segment is successfully deserialized; and generate an error message if the previous segment is not successfully deserialized.
